(19) United States
(12) Patent Application Publication
(10) Pub. No.: US 2016/0190531 A1
(43) Pub. Date: Jun. 30, 2016

(54) STORAGE BATTERY MODULE HAVING IMPROVED PROTECTION, AND STORAGE BATTERY PACK

(71) Applicant: ROBERT BOSCH GMBH, Stuttgart (DE)

(72) Inventors: Markus NEUBERGER, Reutlingen (DE); Lutz MUELLER, Aichtal (DE); Johannes HAESSLER, Brigachtal (DE)

(21) Appl. No.: 14/910,702

(22) PCT Filed: Jun. 18, 2014
(86) PCT No.: PCT/EP2014/062785

§ 371 Date: Feb. 7, 2016

(30) Foreign Application Priority Data
Aug. 6, 2013 (DE) 10 2013 215 492.5

(51) Int. Cl. H01M 2/10; B62M 6/90

(52) U.S. Cl. CPC H01M 2/1094; H01M 2/1077; B62M 6/90; H01M 2220/20

(57) ABSTRACT

A storage battery module includes at least one storage battery cell and a shell enclosing the storage battery cell, the shell including fibers, and spaces remaining between the fibers.

### FIELD OF THE INVENTION

The present invention relates to a storage battery module including an improved protection, in particular against bursting, and a storage battery pack, including a plurality of storage battery modules according to the present invention.

### BACKGROUND INFORMATION

Storage battery modules are known from the related art in different configurations. One intended purpose of storage battery modules of this type is, for example, for electric bicycles, laptops, power tools, where usually a plurality of storage battery modules, including a controller, is enclosed by a plastic housing. However, in particular in the case of lithium-ion batteries, if they are exposed to fire or in the case of faulty modules or faulty wiring, pressure may build up in the interior of the storage battery, which may be relieved by bursting of the outer shell of the storage battery pack. The surroundings may hereby be contaminated with electrolyte. The electrolyte contains solvents and conductive salts whose decomposition may release dangerous decomposition products. Furthermore, the solvents are often flammable and may generate explosive solvent vapor-air mixtures. In order to prevent bursting of the outer shell of the storage battery, a so-called bursting disk is usually incorporated into the outer shell. However, in particular in the case of cylindrical storage battery housings, a so-called “piston effect” may occur due to fast heating, during which the bursting disk may tear, and in the most unfavorable case, the entire contents of the cell may be ejected. In many applications, a plurality of individual storage battery modules is combined into storage battery bundles, which additionally receive yet another outer shell, e.g., made of plastic. However, the outer shell may soften, in particular in the case of a fire, so that undesired “piston effect” may occur even in the case of storage battery packs of this type. Furthermore, a storage battery module is known from DE 10 2011 089 949 A1 which is enclosed by an airtight heat shrink tubing.

### SUMMARY

The storage battery module according to the present invention has the advantage over the related art in that the damaging effects of bursting, and in particular the so-called “piston effect”, in which the entire contents of a storage battery cell are ejected, may be prevented.

The storage battery module according to the present invention thereby has a very cost-efficient and simple structure in spite of this. This is achieved according to the present invention in that the storage battery module includes at least one storage battery cell and a shell enclosing the storage battery cell. The shell is thereby composed exclusively of fibers in such a way that continuous spaces remain between the fibers. The shell according to the present invention thus has a net-like structure or the like, in which spaces between the fibers are present. The enclosing shell thereby enables that, even in the case of a bursting of an outer shell of a storage battery cell, the solid content of the storage battery cell may be kept in the storage battery module without the occurrence of an undesirable ejection or the like, as described in the related art. Thus, according to the present invention, in the case of an undesirable bursting of this type, a safe discharge of the overpressure may take place through, for example, the torn outer shell of the storage battery cell and through the shell. According to the present invention, the term storage battery cell is understood as a rechargeable cell in which, due to, for example, an inadequate charging cycle, the previously mentioned problem may occur.

The shell is preferably manufactured from individual fibers. The fibers are preferably made of electrically non-conductive material and/or have an electrically non-conductive sheathing. In this way, a shell may be manufactured with relatively small spaces between the fibers. Furthermore, the fibers may be processed directly into the shell. Alternatively, the shell is manufactured from fiber bundles. The fiber bundles may hereby have higher strengths than individual fibers. In addition, fibers of different materials may be used in fiber bundles. The fiber bundles are preferably multiple individual fibers twisted with each other or preferably multiple fibers situated in parallel to each other or more preferably multiple fibers interwoven with each other. The fibers are preferably long fibers having a length between 1 mm through 50 mm.

The shell manufactured from fibers is further preferably a fabric or a meshwork or a knit fabric or a scrim fabric. Other manufacturing methods are also conceivable in order to manufacture a shell from fibers with a plurality of spaces. It is particularly preferred when the spaces each have the same size. Moreover, it is preferably also possible to manufacture a shell from a mixture of individual fibers and fiber bundles.

A particularly safe bursting and ejection protection is achieved if the shell covers at least one first front face of the storage battery cell and/or a second front face of the storage battery cell. The storage battery cell is particularly preferably completely enclosed by the shell.

According to one additionally preferred embodiment of the present invention, a plurality of storage battery cells are situated next to each other, for example in rows, and one single shell mutually encloses all storage battery modules. In this way, in particular storage battery modules for larger applications, for example, for electric bicycles, may be manufactured.

The storage battery module further preferably includes a connection element, the spaces between the fibers of the shell being provided in such a way that the connection element is guided through at least one of the spaces between the fibers. Alternatively, the storage battery cell is contacted with the aid of an external contact element through the spaces in the shell. A storage battery control unit is also further preferably situated within the shell.

The shell is preferably a tube. In this way, the shell may be easily pulled over an individual storage battery cell or a plurality of storage battery cells. The tube is preferably closed at a first and/or second end. Alternatively, the shell is a coiled tape which is wrapped around the storage battery cell. The end of the tape may then be fixed, for example, with the aid of gluing to the wrapped outer surface of the shell.

The shell made up of fibers is preferably covered by an additional, in particular water- and dirt-repellent second shell made of metal or plastic. The fiber shell may be applied to the outer side and/or the inner side of the shell.

The fibers are preferably made of a temperature-resistant, flame-retardant or non-flammable and electrically non-conductive material; the fibers are in particular glass fibers or quartz fibers or basalt fibers or aramid fibers or imide fibers or metallic fibers with temperature-resistant insulation. The fibers may also have a coating and/or a sheathing. The shell further preferably includes adhesive in order to fix the fibers with respect to each other.

The storage battery cells are further preferably provided in cylindrical shape.

The present invention furthermore relates to a storage battery pack including a plurality of storage battery modules according to the present invention.

The present invention further relates to a vehicle, in particular an electric bicycle including a storage battery module according to the present invention or a storage battery pack according to the present invention.

The storage battery module further preferably includes a housing into which the shell is integrated. The housing is preferably made of thermoplastic. The fibers situated in the housing increase the stability of the housing. The fibers are preferably extrusion-coated with the material of the housing. The plurality of fibers is preferably provided as knit fabrics or fabrics or meshworks or scrim fabrics and enclosed by the housing material. Alternatively, a shell made from fibers including spaces provided between the fibers is situated on an inner side of the housing.

The fibers integrated into the housing are preferably long fibers having a length between 1 mm through 50 mm.

### BRIEF DESCRIPTION OF THE DRAWINGS

FIG. 1 shows a schematic top view of a storage battery module according to a first exemplary embodiment of the present invention.

FIG. 2 shows a schematic sectional view of the storage battery module from FIG. 1.

FIG. 3 shows an enlarged, schematic top view of one individual storage battery cell of the storage battery module from FIG. 1.

FIG. 4 shows a schematic top view of a storage battery module according to a second exemplary embodiment of the present invention.

FIG. 5 shows a schematic sectional view of the storage battery module from FIG. 4.

### DETAILED DESCRIPTION

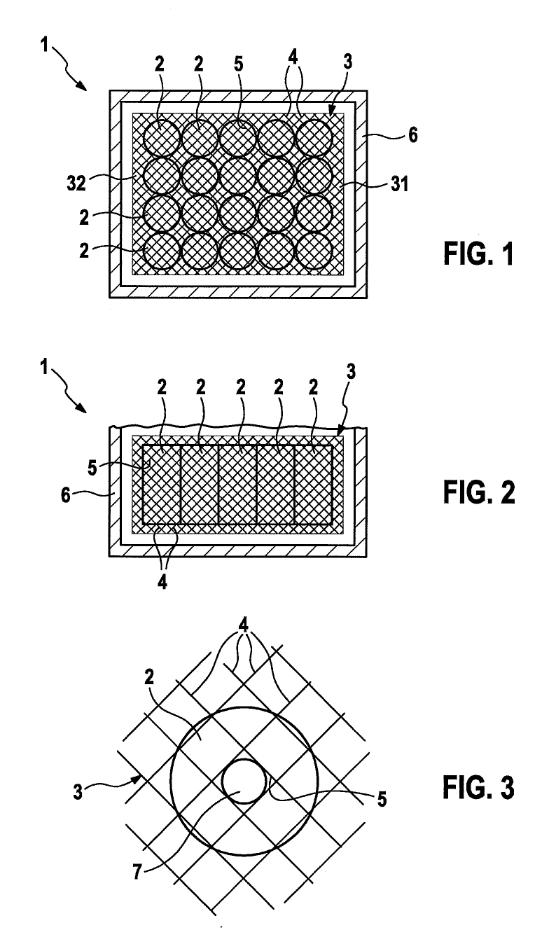

Storage battery module 1 will be subsequently described in detail with reference to FIGS. 1 through 3 according to a first preferred exemplary embodiment.

As is apparent from FIG. 1, storage battery module 1 includes a plurality of storage battery cells 2. Storage battery cells 2 are thereby provided by way of example in four rows situated parallel to each other with five pieces per row. Individual storage battery cells 2 are thereby electrically interconnected with each other.

A single common shell 3 is provided around the plurality of storage battery cells 2. Shell 3 includes a plurality of fibers which are interwoven with each other in this exemplary embodiment. Spaces 5 are thus present between the individual fibers. It should be noted that the fibers may also be woven or knitted or laid. Fibers 4 are thereby formed into the shell in such a way that identically-shaped spaces 5 are created which extend through shell 3 (compare FIG. 3). The spaces thereby have a dimension which is smaller than a minimal dimension of the pieces which are expected to be ejected from the storage battery module.

Individual fibers 4 are thereby situated in two directions in parallel to each other. As is apparent from FIG. 3, a contacting of a connection element 7 of each storage battery cell 2 may be carried out, e.g., through space 5. Either connection element 7 may hereby protrude through space 5 or an external contact element is guided through space 5 and contacts connection element 7 of the storage battery cell. Alternatively, a storage battery control unit may also be situated in the shell.

Shell 3 thus touches the outer housing parts of storage battery cells 2 and the two front faces of storage battery cells 2. Storage battery cells 2 of this exemplary embodiment have a cylindrical shape.

Shell 3 of this exemplary embodiment is provided as a tube and is pulled over the plurality of storage battery cells 2 and is closed on a first end 31 and a second end 32. The closing of the shell may be carried out in different ways, for example by gluing or sewing or the like.

Shell 3 thus forms an essentially net-like structure around the plurality of storage battery cells 2. Thus, in the case of a hazardous situation, in which one or multiple of the storage battery cells has/have burst, shell 3 may prevent inner parts of storage battery cell 2 from being ejected from the storage battery cell housing. Thus, safety of the storage battery module may be significantly improved.

Due to the net-like structure of shell 3, an overpressure may thus be safely discharged through spaces 5 even in the case of a destroyed storage battery cell housing.

Storage battery module 1 of this exemplary embodiment furthermore includes a housing 6 which is preferably manufactured from plastic and accommodates storage battery cells 2. Storage battery module 1 of this exemplary embodiment is used, for example, in electric bicycles.

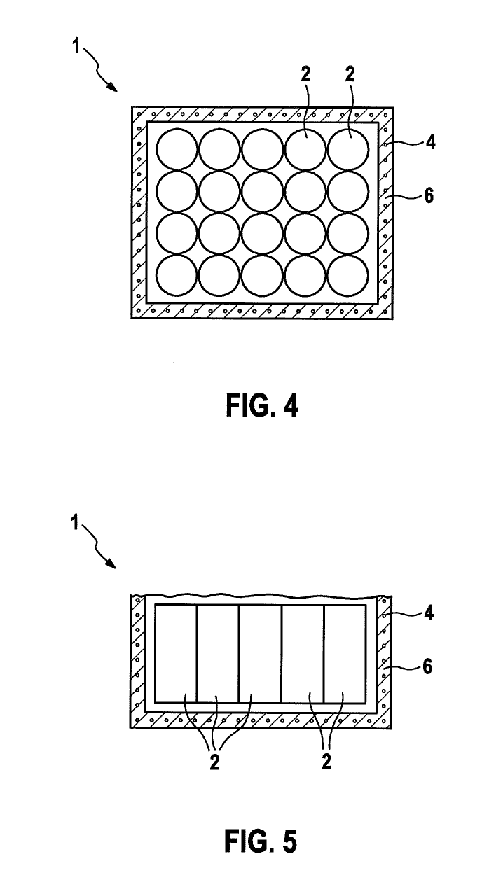

FIGS. 4 and 5 show storage battery module 1 according to a second exemplary embodiment of the present invention. Unlike the first exemplary embodiment, a bursting protection is integrated into housing 6 of storage battery module 1 in the storage battery module of the second exemplary embodiment. A plurality of fibers 4 is thereby integrated into housing 6. Thus, a fiber-reinforced plastic is used as housing 6, which likewise prevents components from the interior of storage battery cell 2 from reaching the surroundings in a hazardous situation.

1.-15. (canceled)

16. A storage battery module, comprising:
at least one storage battery cell; and
a shell enclosing the storage battery cell, wherein:
the shell includes fibers, and
spaces remain between the fibers.

17. The storage battery module as recited in claim 16, wherein the shell is manufactured one of from individual fibers and from fiber bundles.

18. The storage battery module as recited claim 16, wherein the shell includes one of a knit fabric, a fabric, a meshwork, and a scrim fabric.

19. The storage battery module as recited in claim 16, wherein the shell covers at least one of a first front face of the storage battery cell and a second front face of the storage battery cell.

20. The storage battery module as recited in claim 16, wherein the storage battery cell is completely enclosed by the shell.

21. The storage battery module as recited in claim 16, wherein a plurality of storage battery cells is situated next to each other and a common shell encloses all storage battery cells.

22. The storage battery module as recited in claim 16, wherein the spaces between the fibers of the shell are provided in such a way that one of:
electrical contact elements of the storage battery cells are contactable through the spaces in the shell, and
the contact elements of the storage battery cell protrude out of the shell through the spaces.

23. The storage battery module as recited in claim 16, wherein one of:
the shell is a tube which is open or closed at a first end and at a second end, and
the shell is a coiled tape.

24. The storage battery module as recited in claim 16, wherein the shell touches and tightly encloses the storage battery cell.

25. The storage battery module as recited in claim 16, further comprising an additional shell that encloses the fiber-containing shell, wherein the additional shell is made from thermoplastic on at least one of an inner side and an outer side.

26. The storage battery module as recited in claim 16, further comprising a storage battery control unit enclosed by the shell.

27. The storage battery module as recited in claim 16, further comprising a housing into which the fibers are integrated.

28. The storage battery module as recited in claim 27, wherein the housing is manufactured from thermoplastic.

29. The storage battery module as recited in claim 27, wherein one of:
the fibers include one of glass fibers, quartz fibers, basalt fibers, aramid fibers, imide fibers, and metallic fibers with temperature-resistant insulation, and
the fibers are long fibers having a length between 1 mm through 50 mm.

30. A storage battery pack, comprising:
a plurality of storage battery modules, each module comprising:
at least one storage battery cell; and
a shell enclosing the storage battery cell, wherein:
the shell includes fibers, and
spaces remain between the fibers.

31. A vehicle, comprising:
at least one storage battery module, each module comprising:
at least one storage battery cell; and
a shell enclosing the storage battery cell, wherein:
the shell includes fibers, and
spaces remain between the fibers.

32. The vehicle as recited in claim 31, wherein the vehicle includes an electric bicycle.
